(19) United States
(12) Patent Application Publication
(10) Pub. No.: US 2010/0265845 A1
(43) Pub. Date: Oct. 21, 2010

(54) Wireless Local Area Network, Adapter Unit and Equipment

(76) Inventor: Patrik Lampén, Helsinki (FI)

Correspondence Address: BIRCH STEWART KOLASCH & BIRCH, PO BOX 747, FALLS CHURCH, VA, 22040-0747, US

(21) Appl. No.: 11/991,965

(22) PCT Filed: Sep. 14, 2006
(86) PCT No.: PCT/FI2006/000304

§ 371 Date: Jan. 8, 2009

(30) Foreign Application Priority Data
Sep. 15, 2005 (FI) U20050292
Oct. 10, 2005 (FI) 20055549

(51) Int. Cl. H04W 84/12; H04L 12/28; H04W 84/22; H04W 92/04; H04L 9/00; G06F 21/20

(52) U.S. Cl. 370/254; 370/338; 370/329; 713/150; 709/225; 455/557

(57) ABSTRACT

Equipment for a wireless local area network comprises at least one adapter unit (2A to 2G) including a wired network adapter part (22) to be connected to a wired network interface of a computer (WS1 to WS7) and a wireless network adapter part (21), and a wireless network access point (3, 4, 5). The access point (3, 4, 5) and the adapter unit are configured in advance by the supplier of the adapter unit to provide a secure wireless connection only with one another.

### BACKGROUND OF THE INVENTION

The invention relates to a wireless local area network.

A wireless local area network (WLAN) refers to a local area network of a restricted area such as an office, an airport or a hotel, to which the customer terminals within the area are connected wirelessly through the radio path. The most common WLAN standard is the IEEE 802.11 and the different versions thereof. A wireless local area network typically replaces or extends a wired local area network. If both a wired and a wireless local area network are employed in an office, the employees may continue to use the applications and information in the network in the wireless local area network when moving from one work place to another.

A wireless local area network is formed of one or more access points (AP), and of a wireless or wired network that interconnects the access points, and of other active devices, which control the traffic within the network or through a firewall to the Internet. Mobile terminals, which currently still refer mainly to portable computers, communicate over the radio path with the nearest access point. A wireless local area network currently employs a 2.4 GHz frequency.

In order to be able to connect a wireless terminal to a wireless local area network, the terminal must be provided with a WLAN card, and if the network is public, then the user also has to have a subscription to the service provider. Mobile telephone manufacturers and network interface card manufacturers make WLAN cards and the cards may either be external ones or integrated into the device. Currently most of the devices employed in the wireless local area network are portable computers, but in the near future also other mobile stations utilizing WLAN and personal digital assistants (PDA) are likely to become common. In this description the various WLAN devices will be commonly referred to as customer terminals.

Unprotected a wireless local area network poses a threat to the security of the network, and therefore the computer connected to the wireless local area network is to be secured in the same way as a computer attached to a wired local area network. The computer should be provided with a security updated operating system, real-time antivirus software and a firewall. The communications on radio channels provide a special challenge for the security of a wireless local area network. Basically anyone is able to passively pick up a signal transmitted over the radio path and many are those who are capable of actively disturbing the WLAN. The wireless local area network is particularly susceptible to eavesdropping, to block a service and to unauthorized use of the network.

When the WLAN device is brought to the service area of the access point, or it is switched on again, it has to be connected to the access point. The connection requires that the device obtains information about the operation of the network. Therefore the access point sends at predetermined intervals messages including traffic information, i.e. beacon messages. These messages typically include in unencrypted form also the name, i.e. a Service Set ID (SSID), of the common network of the devices in the WLAN subsystem that is used for logically segmenting the subsystem concerned. When the WLAN device is provided with a sufficient amount of information in order to participate in the network traffic, the device starts authentication that is either open or is based on a private key and a challenge-response procedure. In the open authentication the WLAN device and the access point have to be provided with the same SSID in order to be able to establish a connection, and the access point prevents access from customer terminals, which are not provided with the SSID. However, security is poor, since the access point continuously sends the SSID in plain text. Even though sending the SSID would be disabled, an intruder or a hacker may find out the SSID by “snooping”, i.e. monitoring the network traffic unnoticed.

Shared key authentication is more secure. The aim of this process is to ensure that both parties are aware of the same common private key. The access point requests the WLAN device to encrypt the message before transmission, and the received message is decrypted at the access point end. The security scheme of the IEEE 802.11 standard aims to create such conditions that primarily provide the same security as a conventional wired local area network. The object is not to achieve security that spans the entire data connection; instead information is to be protected on the radio path. The first version of the IEEE 802.11 standard concerning security is referred to as WEP (Wired Equivalent Privacy), which in addition to authentication covers securing the information to be transferred using an RC4 stream cipher. The RC4 is a symmetric encryption method, where decryption is carried out with the same private WEP key used for encryption. The most significant problem with symmetric encryption is the exchange of private key between parties. In general the WEP key is input into each computer during the installation of a network interface card, whereby the encryption depends on the reliability of each user.

WEP encryption lost ground when a security hole was revealed, and therefore the IEEE 802.11g version employs a replacement technique WPA (Wi-Fi Protected Access), wherein a session-specific private key is provided and the private key is automatically exchanged using a TKIP protocol (Temporary Key Integrity Protocol). Examples of other substitute techniques include WPA-PSK, AES (Advanced Encryption Standard), DES (Data Encryption Standard), 3DES (Triple DES) etc. Some WLAN manufacturers support authentication based on the physical MAC address of the client's network adapter. The access point allows a connection for the client only if the client's MAC address corresponds with the address in the authentication table of the access point. In addition, authentication servers etc, have been employed.

When a WLAN device is authenticated it is authorized to participate in the operation of the network, and association is started. At this stage the parties exchange information about their abilities, and the network registers the location of the WLAN station. When association is carried out the WLAN device may start transferring data in the network.

Three main types of different wireless local area networks exist. The most typical and known is the private wireless local area network used in companies. Here the portable computers of the employees of a company communicate with the internal network of the company through an access point. Often a firewall is provided between the access point and the internal wired network of the company. The internal wired network is connected to a router, which in turn controls the traffic between the internal network of the company and the Internet. Generally a firewall is also provided between the internal network of the company and the external Internet. City networks and “hot spots” are public wireless local area networks. The hot spots are wireless local area networks provided in certain public premises, through which access to the Internet is possible. Technically a hot spot may be similar to an internal wireless network of an office except that anyone may buy a subscription to a public wireless local area network. Hot spots are found for instance at airports, in hotels and in conference centres. Public wireless local area networks provide access to the open internet. If the user desires to utilize the connection for telecommuting he/she should be provided with a separate data security solution, such as a virtual private network (VPN).

What becomes a problem is to arrange different subscriptions, services and network resources in wireless networks of hot spot type in a way that prevents unauthorized access to the network, provides a secure connection to the users and allows special services for the users, while the adoption and installation of the subscription is easy for the user and possible to implement directly in most computers or corresponding customer terminals.

### BRIEF DESCRIPTION OF THE INVENTION

It is an object of the invention to provide a new solution for providing a wireless local area network subscription to users, particularly in a wireless network of hot spot type.

The object of the invention is achieved with a wireless local area network, an adapter unit and equipment, characterized in what is disclosed in the independent claims. The preferred embodiments of the invention are disclosed in the dependent claims.

In accordance with an embodiment of the invention a service provider of a wireless local area network or another apparatus supplier delivers an apparatus to a customer, a so-called network adapter unit comprising a wireless network adapter part that the service provider or the other apparatus supplier has in advance configured to be connected to the wireless network through a particular access point or particular access points, which provide a predetermined service or services, and a wired network adapter part to be connected to a wired network interface of the customer terminal. The customer terminal can preferably not be used to change or read configuration data. Each access point is configured to allow access to the wireless local area network that takes place only through the compatibly configured adapter unit. Furthermore the service of the customer terminal is determined on the basis of the access point that the network adapter unit connected thereto employs.

Thus the network adapter unit forms, in accordance with the principles of an embodiment of the invention, a part of the wireless local area network controlled by the service provider, even though the network adapter unit is handed over to the customer when used. The customer obtains a device provided with a wired network interface with predetermined properties that the customer is not able to change. The wireless network on the other side of the network adapter remains transparent to the customer terminal; the customer terminal operates as if connected to the wired network. Consequently the customer is not requested to carry out any specific configuration measures as would be the case if the customer terminal were connected to a wireless local area network using a conventional wireless local area network adapter. As regards the customer, the invention provides an easy way to obtain a secure wireless local area network connection with the desired service concept.

For the service provider the invention allows offering tailor-made and secure local area network subscriptions and services to different users even for short periods of time. The customer is provided with a subscription and service when he/she receives the network adapter unit, and the customer loses them when he/she returns the adapter unit. Since the information associated with the access to a wireless network is maintained within the network adapter unit and unattainable from the customer, information that is critical regarding the security of the network is not delivered to the customer. The service obtained by the customer is determined according to the adapter unit that has been handed over, in which case the different services can easily be charged using different adapter unit rents. The present invention is particularly advantageous in situations, where the customer needs a secure and protected network subscription or network resource for temporary use. Such a need arises for instance when sports editors attend sporting events; the invention allows the sports editors to communicate with their editorial staff directly from the stand without having to be near a wired network interface in a media room. Correspondingly a network access and network resources may be provided for participants of conferences, meetings, fairs and other occasions.

In equipment according to an embodiment of the invention comprising an access point and a desired amount of adapter units, the access point and each adapter unit are compatibly configured in advance by the equipment supplier to be wirelessly and securely connected only with each other. The customer is provided with equipment that forms a complete secured local area network. The wireless local area network on the other side of the network adapter remains transparent to the customer terminal, and the customer terminal operates as if connected to a wired network. No specific configuration measures are therefore required of the customer as would be the case if a wireless network were formed in a conventional manner of discrete components and the customer terminal were to be connected to the network by means of a conventional local area network adapter delivered with a computer. For the user the invention enables to easily set up a secure wireless local area network. The secured local area network apparatus that is configured in advance according to the invention is particularly advantageous for establishing a small local area network at home or at the office.

### BRIEF DESCRIPTION OF THE DRAWINGS

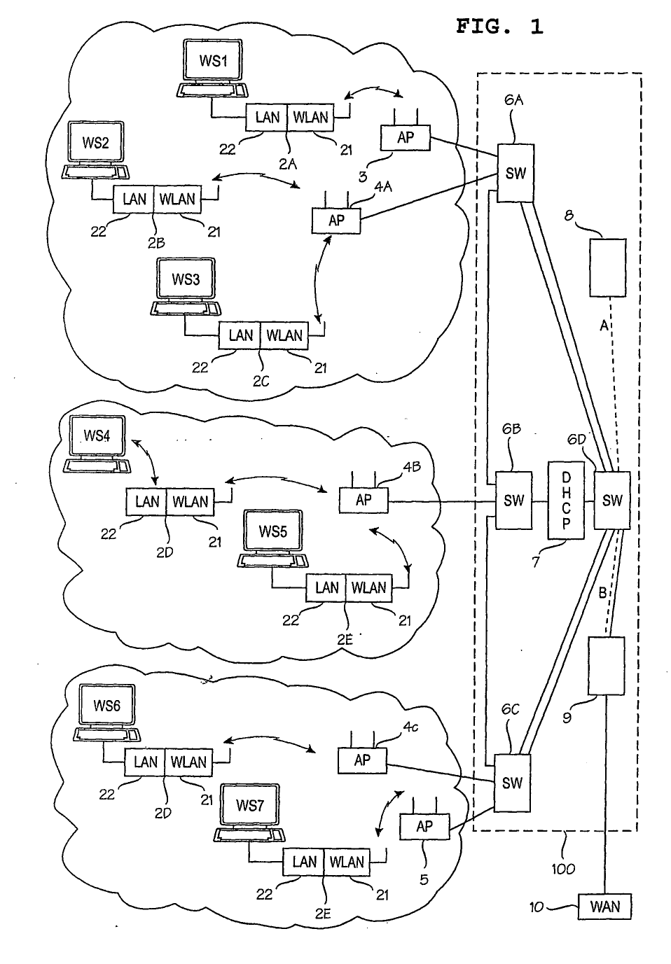

In the following the invention will be explained in greater detail by means of the preferred embodiments with reference to the accompanying drawing, in which FIG. 1 shows an example of a wireless local area network implemented in accordance with the principles of the invention.

### DETAILED DESCRIPTION OF THE INVENTION

The invention can be applied in different types of wireless local area networks. In the following description a wireless local area network according to the IEEE 802 recommendations is used as an example, however, without limiting the invention thereto. The technical properties, requirements and implementations of the WLAN used as an example are all explained in more detail in the recommendations IEEE 802.11b and IEEE 802.11g.

FIG. 1 shows an example of a wireless local area network applying the principles of the present invention. The wireless local area network comprises network adapter units 2A to 2G and access points (AP) 3, 4A, 4B, 4C and 5, which are connected to a larger network infrastructure 100. The network infrastructure 100 symbolically represents any network configuration of a service provider that provides the desired services and/or offers the desired network resources for the customer terminals, e.g. workstations WS1 to WS7. In the example shown in FIG. 1, the network infrastructure comprises switches 6A, 6B, 6C and 6D, a router 9 and servers 7, 8. The wireless local area network infrastructure 100, which may form for instance an intranet, preferably comprises a gateway to a wide area network (WAN) 10, i.e. the Internet.

The customer terminal, e.g. the workstation WS1 to WS7, may be any portable or other computer or corresponding device (a Gameboy, a printer, a PDA etc.) comprising a wired network adapter, such as an Ethernet network interface card. Most computers are currently delivered with a network interface card, whereby they can be directly connected to a wired network without requiring any measures carried out by the user.

Each network adapter unit 2A to 2G may comprise a wireless local area network (WLAN) adapter part 21 and a wired local area network (LAN) adapter part 22. The LAN adapter part 22 forms a wired network interface (for instance Ethernet) to the customer terminal WS1 to WS7. The unit 2A to 2G has the power supplied for instance from a battery, an external power source, through a network interface from the network interface card of the cu stomer terminal (for instance PoE, Power over Ethernet) or from a USB connector in the customer terminal. The customer terminal WS1 to WS7 may be connected to the LAN adapter part 22 with a conventional network cable or in a wireless manner, using for instance Bluetooth, infrared or another short range wireless technique. As regards the customer terminal, the network adapter unit 2A to 2G is similar to any wired network access point. The WLAN adapter part 21 is connected to the infrastructure 100 of the wireless local area network with the secured WLAN connection (IEEE 802.11) through an access point (AP) 3, 4A, 4B, 4C or 5 (also referred to as a base station). Data traffic arriving to the LAN adapter part 22 from the customer terminal is transmitted within the adapter unit 2A to 2G to the WALN adapter part 21, which forwards the data traffic in secured mode to the access point (AP) 3, 4A, 4B, 4C or 5. Correspondingly the security of the data traffic received from the access point (AP) 3, 4A, 4B, 4C or 5 is removed (e.g. decrypted) and the data traffic is transmitted through the LAN adapter part 22 to the customer terminal.

In accordance with an embodiment of the invention the wireless network adapter units 2A to 2G are configured in advance before the units are delivered to the user. For configuration the network adapter unit 2A to 2G may be provided with a graphical user interface or a command line based user interface, for instance through the LAN adapter part. However, unauthorized use of the user interface is not possible for the user of the customer terminal 2A to 2G and access to the configuration data of the network adapter unit may be possible only by means of, for instance, a password or another appropriate technique. A fixed configuration may also be provided in the adapter unit. Thus, the network adapter unit 2A to 2G is, in accordance with the principles of an embodiment of the invention, a part of a wireless local area network controlled by the service provider, even though the network adapter unit is handed over to the customer when used. The customer obtains a device provided with a network subscription with predetermined properties, which the customer is unable to change himself/herself. The wireless local area network on the other side of the network adapter 2A to 2G remains transparent to the customer terminal, the customer terminal operates as if connected to a wired network. Consequently no particular configuration measures are required of the customer as would be the case if the customer terminal were connected to a wireless local area network using a conventional WLAN adapter. As regards the user, the invention provides an easy way to establish a secure wireless local area network connection with the desired service concept.

The invention also provides an easy way to establish a secured local area network controlled by the customer himself/herself. During manufacture, or at sale or delivery the supplier (such as the equipment manufacturer or vendor) of the equipment package comprising an access point and a desired number of adapter units configures the access point and each adapter unit so as to be compatible for a secure wireless communication only with each other. The customer obtains the equipment, which establishes a ready-to-use secured local area network. The wired network interface of the adapter unit is connected to the customer terminal, such as a computer. The access point is connected to a desired target, for instance to provide an Internet connection. The wireless local area network behind the network adapter remains transparent to the customer terminal, the customer terminal operates as if connected to the wired network. Thus, no particular configuration measures are required of the customer for setting up a wireless local area network as would be the case if the customer terminal were to be connected to a wireless local area network, which is set up using separately delivered components, such as a wireless base station and an integrated local area network adapter of the computer. As regards the customer, the invention provides a simple and easy way to establish a secure wireless local area network without requiring a more specific knowledge of the local area network. The customer only needs to buy a ready configured equipment package provided with the desired number of compatibly configured adapter units and access points. Different equipment packages are independent of one another and secured from each other. The local area network equipment according to the invention that is configured and secured in advance is particularly advantageous for establishing a small local area network at home or at the office.

For a service provider the invention enables to provide tailor-made and secure local area network subscriptions for different users even for short periods of time. The customer obtains a network adapter unit when he/she receives the subscription and the service and loses them when he/she returns the adapter unit. Since information associated with access to the wireless network is maintained within the network adapter unit and remains unreachable for the customer, information that is critical to the security of the network is therefore not delivered to the customer.

The configuration of the network adapter unit 2A to 2G may comprise for instance the following information. The user interface of the unit may be provided with a user identification and a password, which allow examining and/or changing the settings of the adapter unit later. The service provider may provide the system software of the WLAN adapter part 21 in advance with a name of the wireless network to be used (SSID), an encryption key index of the network, an encryption algorithm or method to be used (for instance WEP, WPA, WPA-PSK, DES, 3DES, AES), an encryption key and a radio channel to be used. Alternatively the selection of channel can be carried out automatically. The settings are defined according to the fact in which access point (AP) 3, 4A, 4B, 4C or 5 the customer terminal WS1 to WS7 of the user of the network adapter unit is to be logged. Different services may be provided through the different access points (AP) 3, 4A, 4B, 4C or 5.

What is defined in the wired local area network (LAN) adapter part 21 for the network adapter unit 2A to 2G is a static IP address, a sub-network mask, and a default gateway and name servers (DNS) and WINS servers to be used if necessary. These variables can alternatively be retrieved automatically (DHCP) through the wireless local area network infrastructure 100. The DHCP (Dynamic Host Configuration Protocol) is a protocol that is used for allocating a dynamic IP address. The service provider of the system, in this case the wireless local area network 100, provides an IP address area for the HDCP and each customer terminal WS1 to WS8 includes TCP/IP software requesting the IP address from the DHCP server. In the example shown in FIG. 1 the server 7 is a DHCP server that distributes the information concerned to the customer terminals 2A to 2G via the intranet, the switches 6A to 6D, the access point (AP) 3, 4A, 4B, 4C, 5 and the network adapter unit 2A to 2G. The server 7 itself may also operate as the DNS and/or WINS server and resolve the name (DNS, WINS) of the intranet resources or resolve (DNS) Internet addresses. In an embodiment of the invention, the system software of the LAN adapter part 21 may configure it to distribute the IP address, the subnetwork mask and the default gateway and the name servers (DNS) and WINS servers automatically (DHCP) to the customer terminal connected thereto. In a way the adapter part 21 thus operates as the DHCP server. The network adapter unit according to the invention may be implemented, for instance, using an access point DWL-730AP of the D-Link Systems Inc, the Ethernet interface of which receives a network cable of the customer terminal and is powered from the USB connector of the customer terminal. The service provider configures the DWL-730AP to operate in accordance with the principles of the invention.

In the example shown in FIG. 1, the network infrastructure 100 comprises controllable network switches 6A to 6D, which are used to connect the access points (AP) 3, 4A, 4B, 4C and 5 of the wireless network with each other and/or to different services offered in the network and/or to the Internet 10. What is defined for the network adapter of the local area network side of the router 9 is a fixed IP address, which operates as the default gateway of the wireless customer terminals WS1 to WS7 to the Internet 10. The network adapter of the external network 10 of the router 9 automatically (DHCP) retrieves the IP address and the addresses of the name server from the network of the service provider. Alternatively they can be inputted into the router manually. The router may also comprise a firewall and services corresponding to the DHCP, DHS, WINS, file and/or resource servers 7 and 8. In an embodiment the maximum speed of the ports of the different switches 6A to 6D can be limited, in which case Internet connections operating at different speeds may be offered to be used by the customer terminals WS1 to WS7 according to the access point through which the connection is established. In an embodiment, virtual networks (VLAN) may be created in the switch network, the virtual networks enabling access to some or all of these services. In the example shown in FIG. 1, the service provided in addition to the Internet service is a file and resource server 8, from which shared disk resources, the right of use of software or other services can be assigned to different users. An example of an appropriate router 9 is a DFL-700 of the D-Link Systems Inc, which comprises a firewall and a router, which employs the DHCP for distributing IP addresses.

Each access point (AP) 3, 4A, 4B, 4C and 5 is fixedly connected to a port in one of the switches 6A to 6D of the network infrastructure 100. The system software of the access point 3 is provided with a user name and a password, which allow checking and/or changing the settings of the access point later through the user interface. What is also inputted in advance into the system software, for instance through the service provider or the apparatus manufacturer, is a name of the wireless network to be used (SSID), an encryption key index of the network, an encryption algorithm or method to be used (for example WEP, WPA, WPA-PSK, DES, 3DES or AES), an encryption key and the radio channel to be used. Alternatively the selection of channel can be set to take place automatically. The settings are defined according to the customer terminals, which are to be logged in to this particular access point, or according to the services, which are to be provided through the access point. The network name (SSID) can also be hidden in order to improve data security. If the wired network adapter part 22 in the network adapter unit 2A to 2G is used to automatically distribute the IP address, the sub-network mask, the default gateway, the name servers and/or the WINS servers to the customer terminal connected thereto, then the access point may employ a MAC filter, in which case only the predetermined network adapter units with matching MAC addresses can access to the access point 110 or to the network infrastructure 100 through the access point. Consequently access to the network infrastructure can be prevented even though the name of the wireless network, the radio channel to be used, the encryption algorithm and the encryption key were known to the user. An example of an appropriate access point (AP) 3, 4A, 4B, 4C and 5 is the DWL-2100SP of the D-Link Systems Inc.

Let us examine, by way of example, how the customers may in accordance with the invention be provided with different services depending on to which access point the network adapter 2A to 2G is configured to be connected. The same principle can be applied to create a desired number of different services.

The network adapter units 2A and 2B are configured such that they are logged in the access point (AP) 3 or in another similarly configured access point. The adapter units 2A and 2B as well as the access point (AP) 3 thus form a pre-configured equipment package. The access point (AP) 3 is in turn connected to a port at the switch 6A of the network infrastructure 100. The switches of the infrastructure 100 are configured such that the customer terminals WS1 and WS2, which have a wireless connection through the network adapter units 2A and 2B to the access point 3 may have access to the disk or other network resources with a separate server 8 and to the Internet connection through a router 9.

The access points (AP) 4A, 4B and 4C are configured identically among one another. The network adapter units 2C, 2D, 2E and 2F are configured such that they may be logged in the access points (AP) 4A, 4B and 4C or in other correspondingly configured access points. The access point 4A is connected to a port at the switch 6A, the access point 4B is connected to a port at the switch 6B and the access point 4C is connected to a port at the switch 6C. The switches of the infrastructure 100 are configured such that the customer terminals WS3 to WS6 having wireless connection through the network adapter units 2C, 2D, 2E and 2F to the access points 4A, 4B and 4C have access to the Internet only through the router 9.

The network adapter 2G is configured such that it is logged in the access point (AP) 5 or in another similarly configured access point. The access point (AP) 5 is in turn connected to a port at the switch 6C. The switches of the infrastructure 100 are configured such that the customer terminal WS7, which is wirelessly connected through the network adapter units 2A and 2B to the access point 5 has access to the Internet at limited speed through the router 9. The speed limitation of the Internet connection is set to the port of the switch 6C or 6D.

The infrastructure shown in FIG. 1 can be provided with a new secured local area network by providing a new equipment package according to the invention comprising a compatibly configured access point and an adapter unit.

A simple local area network infrastructure, such as a home network, can be established using a single equipment package, for instance the adapter unit 2A and 2B and access point (AP) 3. The access point is connected directly to the desired service or to the network, for instance with an ADSL modem to the Internet. The only measures required of the user are then connecting the network interface of the computer to the adapter unit and connecting the access point to the ADSL modem, for instance with a LAN cable. No configurations taking place in the computer are required.

The wireless local area network according to the invention is preferably arranged to prevent connections between customer terminals and to allow only the connection from the customer terminal to the Internet or another service intended thereto. A customer terminal can preferably not observe presence of other terminals in the wireless local area network. These measures increase the security of the wireless local area network.

It is apparent to those skilled in the art that as technology progresses the basic idea of the invention can be implemented in various ways. The invention and the embodiments thereof are therefore not restricted to the above examples but may vary within the scope of the claims.

1. A local area network comprising at least one access point (3, 4, 5) for connecting at least one customer computer (WS1 to WS7) over a wireless interface to the local area network, characterized in that the local area network comprises at least one adapter unit (2A to 2G) including a wireless network adapter part (21), which is in advance configured for a secure wireless connection with a predetermined access point (3, 4, 5) of the wireless network, and a wired network adapter part (22) to be connected to a wired network interface of the customer terminal (WS1 to WS7), and in that the access point (3, 4) is configured in advance to allow the access to a wireless local area network only from the compatibly configured adapter unit (2A to 2G).

2. A local area network as claimed in claim 1, characterized in that the local area network comprises at least two differently configured access points (3, 4, 5) for different services and/or user groups, and in that each adapter unit (2A to 2G) is configured to be connected to an access point or access points with one type of configuration only.

3. A local area network as claimed in claim 1 or 2, characterized in that access of the customer computer (WS1 to WS7) is prevented to the configuration data of the adapter unit (2A to 2G).

4. A local area network as claimed in claim 1, 2 or 3, characterized in that the configuration data of the access point (3, 4, 5) and the adapter unit (2A to 2G) comprise one or more of the following: a name of the wireless network, an encryption key index of the network, an encryption algorithm or method to be used, an encryption key and a radio channel to be used.

5. A local area network as claimed in claim 1, 2, 3 or 4, characterized in that an IP address, a sub-network mask and/or a default gateway and name servers and possible WINS servers for the customer terminal (WS1 to WS7) are configured or retrieved through the wireless network to the wired network adapter part (22) of the adapter unit (2A to 2G), or the wired network adapter part (22) is arranged to automatically distribute them.

6. A local area network as claimed in any one of the previous claims, characterized in that the access points (3, 4, 5) are arranged to hide or to remove the name of the wireless network in their transmission, that the local area network comprises means for hiding and securing the customer terminals and the connections thereof from one another.

7. A local area network as claimed in any one of the previous claims, characterized in that at least one access point (3, 4, 5) comprises a device address filter for allowing connection to the network for only the adapter units provided with particular device addresses.

8. A local area network as claimed in any one of the previous claims, characterized in that the local area network comprises a server (7) for distributing one or more of the following data items through the access point and the adapter unit to the customer terminal; an IP address, a subnetwork mask and/or a default gateway and name servers and WINS servers.

9. A local area network as claimed in any one of the previous claims, characterized in that the local area network comprises means (6A to 6D), preferably one or more switches for providing an Internet connection and/or a memory resource and/or another network resource to the customer computer (WS1 to WS7) according to the access point (3, 4, 5) used for connection.

10. A local area network as claimed in claim 9, characterized in that the means (6A to 6D) comprise means for creating virtual networks of the access points (3, 4, 5) to the services and/or network resources addressed thereto.

11. An adapter unit for connecting a computer (WS1 to WS7) over a wireless interface to an access point (3, 4, 5) of a wireless local area network, characterized in that an adapter unit (2A to 2G) comprises both a wired network adapter part (22) to be connected to a wired network interface of the computer (WS1 to WS7) and a wireless network adapter part (21), which is configured in advance by the supplier of the adapter unit to provide a secure wireless connection only to a predetermined access point (3, 4, 5) compatibly configured in advance by the supplier of the adapter unit.

12. Equipment for a wireless local area network, characterized in that the equipment comprise at least one adapter unit (2A to 2G) including a wired network adapter part (22) to be connected to a wired network interface of a computer (WS1 to WS7), and a wireless network adapter part (21), and a wireless network access point (3, 4, 5), and that the access point (3, 4, 5) and said at least one adapter unit are compatibly configured in advance by the supplier of the adapter unit to provide a wireless secure connection only with one another.

13. Equipment as claimed in claim 12, characterized in that the configuration data of the access point (3, 4, 5) and the at least one adapter unit (2A to 2G) include one or more of the following: a name of the wireless network, an encryption key index of the network, an encryption algorithm or method, an encryption key and a radio channel.

14. Equipment as claimed in claim 12 or 13, characterized in that the access point (3, 4, 5) comprises a hardware address filter for allowing connection for only the adapter units provided with particular hardware addresses.

15. Equipment as claimed in claim 12, 13 or 14, characterized in that the access point (3, 4, 5) is arranged to hide or remove the name of the wireless network during transmission, and that the equipment comprise means for hiding and securing the customer terminals and the connections thereof from one another.
